(19) United States
(12) Patent Application Publication
(10) Pub. No.: US 2014/0011542 A1
(43) Pub. Date: Jan. 9, 2014

(54) NETWORK TELEPHONE SWITCHBOARD

(71) Applicant: JIA TENG TECHNOLOGY CO.,LTD., Taipei City (TW)

(72) Inventors: Ta-Wei HU, Keelung City (TW); Chuan-Chih LIN, Taipei (TW)

(73) Assignee: Jia Teng Technology Co.,Ltd., Taipei City (TW)

(21) Appl. No.: 13/738,130

(22) Filed: Jan. 10, 2013

(30) Foreign Application Priority Data
Jul. 5, 2012 (TW) 101213031

(51) Int. Cl. H04W 88/14

(52) U.S. Cl. CPC H04W 88/14
USPC 455/560

(57) ABSTRACT

A network telephone switchboard at least includes a processing unit; a radio frequency (RF) unit connected to the processing unit; a memory unit connected to the processing unit; a connection unit connected to the processing unit; and a display unit connected to the processing unit. The network telephone switchboard can be connected to outside connections such as Telecom companies or inside connections such as network telephones, smart phones (like iPhone or Android) as extension telephones of mobile phones for multi-party conversation, call forwarding, and voice mail etc, thus achieving the purposes of easy to install, reduced set-up costs, enhanced call quality, increased working efficiency, lowered call costs and reduce in the waste of resources.

### BACKGROUND OF THE INVENTION

1. Field of the Invention

The present invention relates to a network telephone switchboard, particularly to a network telephone switchboard which can be connected to outside connections such as Telecom companies or inside connections such as network telephones and smart phones for the use of multi-party conversation, call forwarding, and voice mail etc, thus achieving the purposes of being easy to install, reduced set-up costs, enhanced call quality, increased working efficiency, lowered call costs and reduce in the waste of resources.

2. Description of Related Art

Currently available communication means in the office is majorly a traditional phone. In some cases, although the communication can be made through the computer Skype, MSN and other Internet phones and call costs can be saved compared to traditional telephone, it still cannot fully replace the traditional phone with them because the currently network telephones are based passive way (pull call) which checks at any time if there is external call comes in and thus the computer servers in use always check a waste of resources. This causes the poor phone service quality and working efficiency. Accordingly, office call costs will increase. Moreover, the traditional phones cannot be linked to computer-related records when the companies expand their branches overseas, often resulting in blind corners of confidential telephone management. Therefore, the conventional phones or Internet phones cannot meet the requirements for the users in actual use.

For this reason, the inventors has studied and proceeded in-depth discussion, and actively seek approaches for many years engaged in the research and experiences of related industries and manufacturing. After long-term research and efforts in development, the inventors has finally the successfully developed this invention “network telephone switchboard” which overcomes the shortages in the prior art.

### SUMMARY OF THE INVENTION

A main purpose of this invention is to provide a network telephone switchboard which can be connected to outside connections such as Telecom companies or inside connections such as network phones and smart phones for the use of multi-party conversation, call forwarding, and voice mail etc, thus achieving the purposes of being easy to install, reduced set-up costs, enhanced call quality, increased working efficiency, lowered call costs and reduce in the waste of resources.

In order to achieve the above and other objectives, the network telephone switchboard of the invention at least includes a processing unit; a radio frequency (RF) unit connected to the processing unit; a memory unit connected to the processing unit; a connection unit connected to the processing unit; and a display unit connected to the processing unit.

In one embodiment of the invention, the processing unit, the RF unit, the memory unit, the connection unit and the display unit are combined with a housing each other.

In one embodiment of the invention, the processing unit, the RF unit and the memory unit are disposed in the housing, and the connection unit and the display unit are located at both end surfaces of the housing.

In one embodiment of the invention, the processing unit is a single chip, wafer, or logic circuit.

In one embodiment of the invention, the RF unit is Communication Agreement 802.11.

In one embodiment of the invention, the memory unit is a flash memory or synchronous dynamic random access memory.

In one embodiment of the invention, the connection unit includes an USB connector, an audio connector, and an RJ45 connector.

In one embodiment of the invention, the display unit contains a plurality of light emitting diodes.

### BRIEF DESCRIPTION OF THE DRAWINGS

FIG. 1 is a schematic view of an appearance of a network telephone switchboard according to the invention.

FIG. 2 is a schematic block diagram of a network telephone switchboard according to the invention.

FIG. 3 is schematic view of use status of a network telephone switchboard according to the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

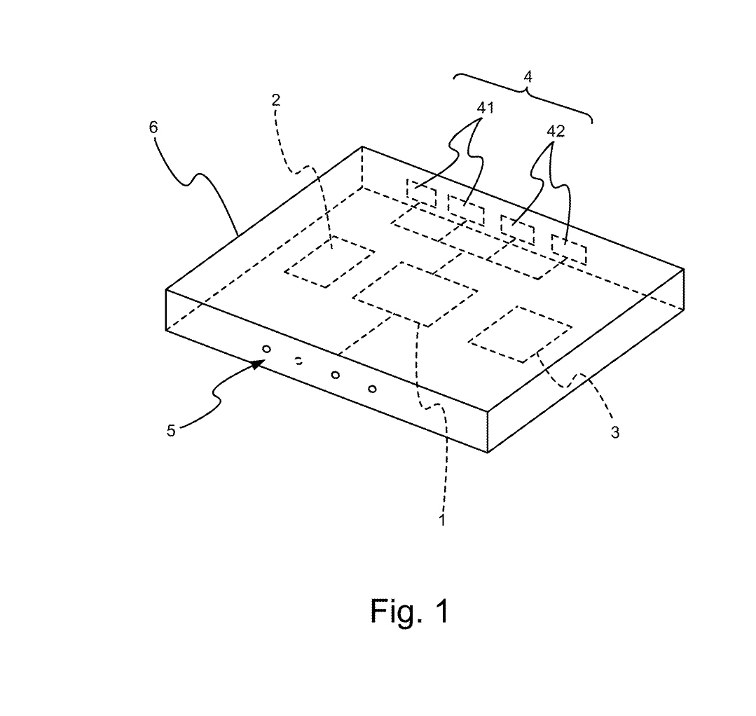

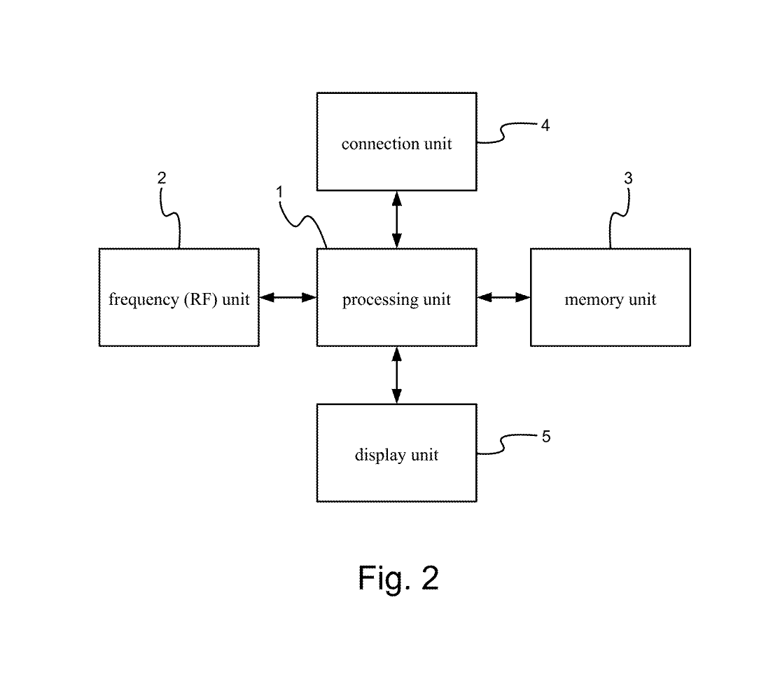

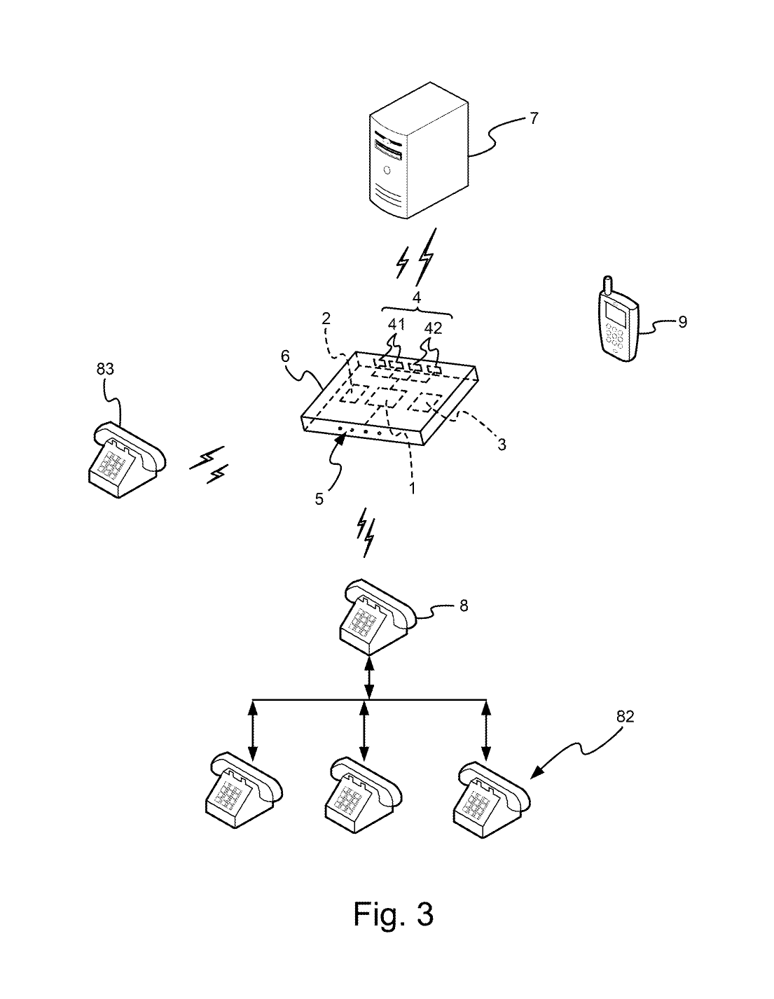

FIG. 1 is a schematic view of an appearance of a network telephone switchboard according to the invention. FIG. 2 is a schematic block diagram of a network telephone switchboard according to the invention. FIG. 3 is schematic view of use status of a network telephone switchboard according to the invention. As shown, the network telephone switchboard at least includes a processing unit 1, a radio frequency (RF) unit 2, a memory unit 3, a connection unit 4, and a display unit 5. The processing unit 1, the RF unit 2, the memory unit 3, the connection unit 4 and the display unit 5 are combined with a housing 6 each other The processing unit 1, the RF unit 2 and the memory unit 3 are disposed in the housing 6. The connection unit 4 and the display unit 5 are located at both end surfaces of the housing 6.

The processing unit 1 is a single chip, wafer, or logic circuit.

The RF unit 2 is connected to the processing unit 1, and can be Communication Agreement 802.11, for example.

The memory unit 3 is connected to the processing unit 1, and can be a flash memory or synchronous dynamic random access memory.

The connection unit 4 is connected to the processing unit 1, and includes an USB connector 41 and an RJ45 connector 42.

The display unit 5 is connected to the processing unit 1, and contains a plurality of light emitting diodes. Thereby, the above-mentioned components constitute a completely new network telephone switchboard.

When the network telephone switchboard of the invention is put into practice, the connecting unit 4 and the RF unit 2 are connected to a Telecom company 7, a network telephone 8 and a remote network telephone 82. The display unit 5 shows the connection status of being normal or abnormal (identifying by different light colors at different locations). The processing unit 1 has an embedded Linux system. When the outside connection 9 such as mobile phone, household phone or Internet phone like Skype or MSN is made, the call is put through by means of the processing unit 1 and the network telephone 8 or remote network telephone 82 from the Telecom company 7. When the invention is in use, the invention allows the user to set that the incoming call will be automatically transferred out (home or to other destinations, for example) through an extension telephone 81 of a domestic network telephone, as long as a local network keeps the extension telephone 81 free to call. Furthermore, when the outside connection 9 reaches (or others calls), with the use of the processing unit 1, a multi-party conversation can be made between the domestic network telephone 8, the extension telephone 81 of the domestic network telephone, the extension telephone 82 of the remote domestic network telephone and/or the outside connection 9. With the cooperation of the processing unit 1 and the memory unit 3, any extension numbers, mobile phone numbers or domestic network telephone number input to the domestic network telephone 8, the extension telephone 81 of the domestic network telephone, or the extension telephone 82 of the remote domestic network telephone will be stored in the memory unit 3. When the outside connection 9 is made, the call will be transferred to a designated telephone number.

In addition, with the cooperation of the processing unit 1 and the memory unit 3, greetings and personal voicemails can be recorded. After recording the recorded voice data is stored in the memory unit 3. Therefore, in case of poor reception or being inconvenient to answer the call for the user, the outside connection 9 can make a voicemail.

In summary, the network telephone switchboard of the invention can effectively improve the shortcomings of the conventional technology, and can be connected to the Telecom company, the domestic network telephone, the extension telephone of the domestic network telephone and the extension telephone of the remote domestic network telephone for multi-party conversation, call forwarding, and voice mail etc, thus achieving the purposes of being easy to install, reduced set-up costs, enhanced communication efficiency, lowered call costs and reduce in the waste of resources. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A network telephone switchboard at least comprising
a processing unit;
a radio frequency (RF) unit, connected to the processing unit;
a memory unit, connected to the processing unit;
a connection unit, connected to the processing unit; and
a display unit, connected to the processing unit.

2. The network telephone switchboard of claim 1, wherein the processing unit, the RF unit, the memory unit, the connection unit and the display unit are combined with a housing each other.

3. The network telephone switchboard of claim 2, wherein the processing unit, the RF unit and the memory unit are disposed in the housing; and the connection unit and the display unit are located at both end surfaces of the housing.

4. The network telephone switchboard of claim 2, wherein the processing unit is a single chip, wafer, or logic circuit.

5. The network telephone switchboard of claim 2, wherein the RF unit is Communication Agreement 802.11.

6. The network telephone switchboard of claim 2, wherein the memory unit is a flash memory or synchronous dynamic random access memory.

7. The network telephone switchboard of claim 2, wherein the connection unit includes an USB connector, an audio connector, and an RJ45 connector.

8. The network telephone switchboard of claim 2, wherein the display unit contains a plurality of light emitting diodes.
